(19) United States
(12) Patent Application Publication
(10) Pub. No.: US 2010/0214062 A1
(43) Pub. Date: Aug. 26, 2010

(54) VERIFICATION APPARATUS AND AUTHENTICATION APPARATUS

(75) Inventor: Naoko HAYASHIDA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/709,610

(22) Filed: Feb. 22, 2010

(30) Foreign Application Priority Data
Feb. 20, 2009 (JP) 2009-37770

(51) Int. Cl. G05B 19/00

(52) U.S. Cl. 340/5.82

(57) ABSTRACT

A verification apparatus includes a storage unit storing a plurality of pieces of verification biometric information on a per group basis with personal identification information unmapped to the verification biometric information and a verification unit performing a 1:N verification operation on the verification biometric information of a verification target person read by read unit and the plurality of pieces of verification biometric information on a per group basis.

### CROSS-REFERENCE TO RELATED APPLICATIONS

This application is based upon and claims the benefit of priority of the prior Japanese Patent Application No. 2009-37770, filed on Feb. 20, 2009, the entire contents of which are incorporated herein by reference.

### BACKGROUND

Various embodiments described herein relate to a verification apparatus, an authentication apparatus, and a verification method for performing a verification process based on biometric information.

Biometric authentication is being widely used. In the biometric authentication, individuals are authenticated using the biometric information such as of fingerprint, vein, etc. In 1:N (one to many) authentication system using biometrics, not based on identification, users are authenticated by simply supplying their biometric information without specifying their identification. The biometric authentication thus provides a high degree of user friendliness. The number of authentication target subjects that can be authenticated at a time is limited because of the authentication time and authentication accuracy considerations. For example, in an authentication system having a scale of a total of 1500 users, the number of users authenticatable at a time at 1:N is 500 or so.

### SUMMARY

A verification apparatus includes storage unit storing a plurality of pieces of verification biometric information on a per group basis with personal identification information unmapped to the verification biometric information; and verification unit performing a 1:N verification operation on the verification biometric information of a verification target person read by read unit and the plurality of pieces of verification biometric information on a per group basis.

The object and advantages of the various embodiments will be realized and attained by means of the elements and combinations particularly pointed out in the claims. It is to be understood that both the foregoing general description and the following detailed description are exemplary and explanatory and are not restrictive of the various embodiments, as claimed.

### BRIEF DESCRIPTION OF THE DRAWINGS

FIG. 1 is a block diagram generally illustrating a verification apparatus of a first embodiment.

FIG. 2 illustrates how verification data of a copying machine is managed.

FIG. 3 illustrates a structure of the verification data.

FIG. 4 illustrates a storage method of storing mapping between the verification data and user identifications (IDs).

FIG. 5 is a block diagram of a verification apparatus and an authentication apparatus in accordance with a second embodiment.

FIG. 6 is a flowchart of a verification process of the verification apparatus.

FIG. 7 is a flowchart of a 1:N verification process.

FIG. 8 is a flowchart of a user authentication process of the authentication apparatus.

FIGS. 9A and 9B are flowcharts of a structure modification process of the verification data.

FIGS. 10A and 10B are a flowchart of an update process of the verification data.

FIG. 11 illustrates how an entrance/exit management apparatus manages verification data.

FIG. 12 illustrates how a shared PC manages verification data.

FIG. 13 illustrates an authentication screen for controlling user attribute information.

FIG. 14 is a block diagram of an authentication apparatus, a verification apparatus, and a coordinating system in accordance with a third embodiment.

FIG. 15 is a flowchart of a basic information update process.

FIG. 16 is a flowchart of the basic information update process with the coordinating system employed.

FIGS. 17A and 17B illustrate another example of the verification data.

### DESCRIPTION OF EMBODIMENTS

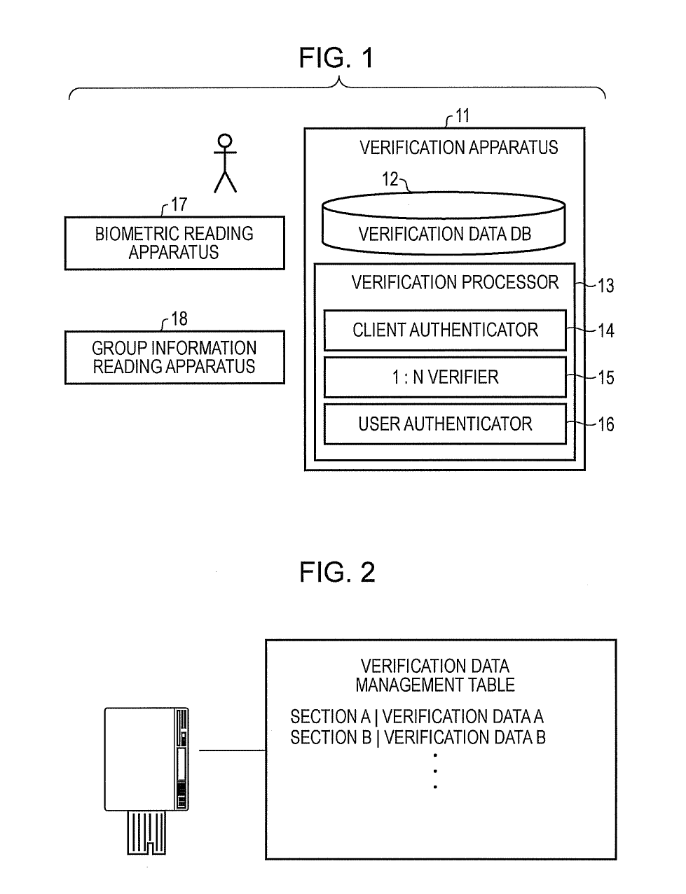

The various embodiments are described below with reference to the drawings. FIG. 1 illustrates a structure of a verification apparatus 11 of a first embodiment. The verification apparatus 11 of the first embodiment stores verification biometric information of a plurality of persons by group with personal identification information unmapped to the verification biometric information, and performs biometric authentication without the need to use an external authentication apparatus.

The biometric information is biological information, such as fingerprint data, vein data, iris data, or the like. The biometric information may also be data that is obtained by extracting a feature from the biological information and then by coding the feature. The biometric information may be biometric information itself or may be data that is derived by converting whole or part of the biometric information. The biometric information for verification is hereinafter referred to as verification data.

The verification apparatus 11 includes a verification data database 12 and a verification processor 13. The verification data database 12 (storage unit) stores verification biometric information on a per group basis (the minimum number of persons of each group is one). The verification processor 13 includes client authenticator 14, 1:N verifier 15, and user authenticator 16.

A user inputs their own biometric information to the verification apparatus 11 using a biometric reading apparatus 17. The user also causes a group information reading apparatus 18 to read information regarding a group to which the user belongs.

The client authenticator 14 identifies a verification target person read by the biometric reading apparatus 17 and then determines whether to perform a verification operation. The 1:N verifier 15 performs a 1:N verification process by checking the biometric information of the verification target person read by the biometric reading apparatus 17 against a plurality of pieces of verification biometric information of a group matching group information.

The user authenticator 16 authenticates the verification target person as a registered user if the 1:N verifier 15 determines that particular verification biometric information matches the biometric information of the verification target person.

The biometric reading apparatus 17 may be a vein sensor reading the vein in a finger or palm, a fingerprint sensor reading a fingerprint, or the like. The group information reading apparatus 18 may be an apparatus that reads, from a magnetic card, an IC card, or the like, data indicating a group to which the verification target person belongs.

FIG. 2 illustrates how a copying machine manages verification data. At an office, for example, users of the copying machine are grouped according to section, and the verification biometric information of a plurality of users at each section is pre-stored on a storage device (for example, a memory or the like) of the copying machine. The number of copies is managed on a per section basis. Registered on a verification data management table illustrated in FIG. 2 are the verification biometric information of a plurality of users working at section A (hereinafter referred to as verification data A) and verification data B of a plurality of users working at section B.

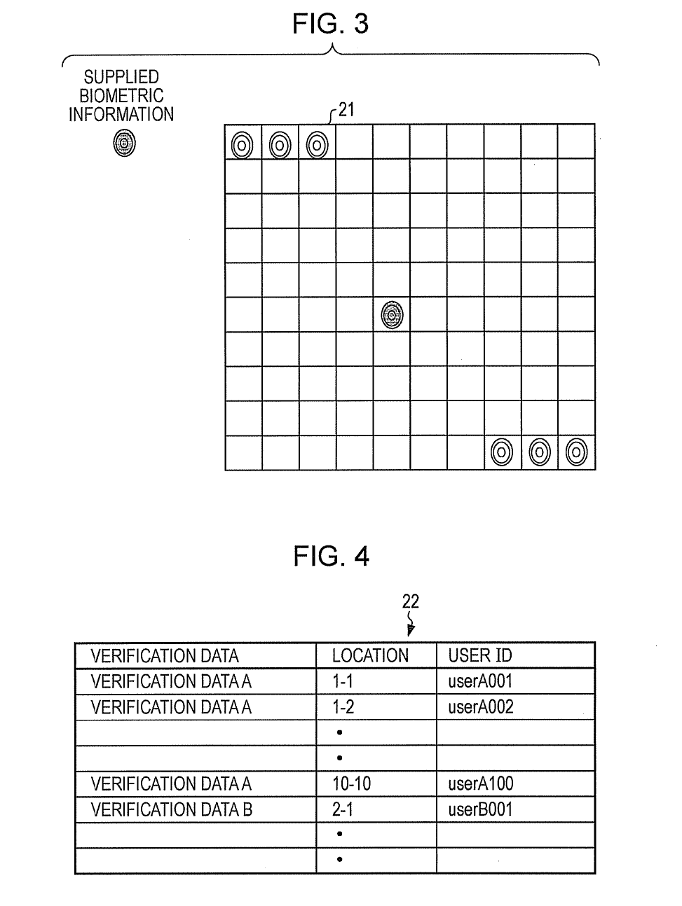

FIG. 3 illustrates verification data A21 of the section A illustrated in FIG. 2. Referring to FIG. 3, the biometric information (such as fingerprint data) of the plurality of users at the section A is stored at storage locations of a memory area delineated in a matrix configuration on a database with the biometric information mapped to the respective storage location of the memory area.

If a group (section) of the verification target person is identified, the biometric information of the verification target person is checked against the verification data A21 of the corresponding group in FIG. 3 for the 1:N verification process. If a supplied verification biometric information is matched with a verification biometric information which is included in the verification data A21, index data indicating the storage location of the verification biometric information in the memory area is acquired.

FIG. 3 illustrates the verification biometric information of a plurality of persons stored on a memory area of 10×10 cells on a per group basis. For example, the verification data of the persons at the section A is stored at locations defined by the first row and the first through third columns, and at a location defined by the six row and the fifth column. The rows and columns are numbered with the first row and the first column starting from the top and the leftmost side on the chart in FIG. 3. The verification biometric information of the persons at the section A is stored at locations defined by the tenth row and the seventh through tenth columns (locations 10-7 through 10-10).

When the biometric information of the verification target person is read with the assigned group identified, the biometric information of the verification target person is checked against a plurality of pieces of verification biometric information of the group in FIG. 3. In this way, it is determined whether the biometric information of the verification target person matches the registered verification biometric information.

If the verification results show that the biometric information of the verification target person matches the verification biometric information at the location defined by the sixth row and the fifth column, location data indicating the storage location of that data is stored. In this way, the verification process records the position of the memory area storing the verification biometric information which the biometric information of the verification target person has been checked against.

In one method of storing the verification biometric information and the storage location in a mapped state, one frame of a matrix memory area stores the verification biometric information of a plurality of users in one group. Alternatively, one frame of a matrix memory area stores the verification biometric information of a plurality of users of a plurality of groups. The storage method of the verification data is not limited to the above-described methods. It is important that a data structure permitting the 1:N verification process to be performed be used on a per group basis. By storing the verification biometric information of the persons of the same group as a chunk of data, a plurality of pieces of verification biometric information of the same group are read at a time. The verification time of the 1:N verification process is shortened. The biometric information may be encrypted before being stored. The biometric information may also be obfuscated by adding other data thereto before being stored.

In accordance with the first embodiment, the 1:N verification time is shortened by verifying the verification biometric information on a per group basis. The verification data database 12 in the verification apparatus 11 stores the verification biometric information and personal identification information in an unmapped state. Even if the stored data leaks out of the verification apparatus 11, mapping the personal identification information to the biometric information remains difficult. The risk of leakage of personal information is thus reduced.

The verification apparatus 11 has no information that maps the verification biometric information to the personal identification information, and history information indicating the verified user is not stored on the verification apparatus 11. As a result, even if information leaks from the verification apparatus 11, the leakage of personal verification history information is unlikely.

If the verification target person is to be recorded, the verification apparatus 11 may separately store data mapping to a user identification (ID) the location data indicating the storage location of the verification biometric information, and may identify the verification target person using the data.

FIG. 4 illustrates a storage method of storing the mapping between the location data of the verification data including a plurality of pieces of verification biometric information and the user ID.

A mapping table 22 illustrated in FIG. 4 lists a name of verification data of each group, location data indicating the storage location of the verification biometric information for users, and the user ID in a mapped state.

If the verification results indicate that the biometric information of the verification target person matches particular verification biometric information of the verification data A, the location data indicating the storage location of the verification biometric information is stored on the memory or the like. Referencing the mapping table 22 illustrated in FIG. 22, the corresponding user ID is acquired.

Even if the above-described mapping table 22 is arranged on the verification apparatus 11, the verification biometric information for use in authentication is not directly mapped to the personal identification information (such as the user ID). The risk of leak of the personal information is thus reduced.

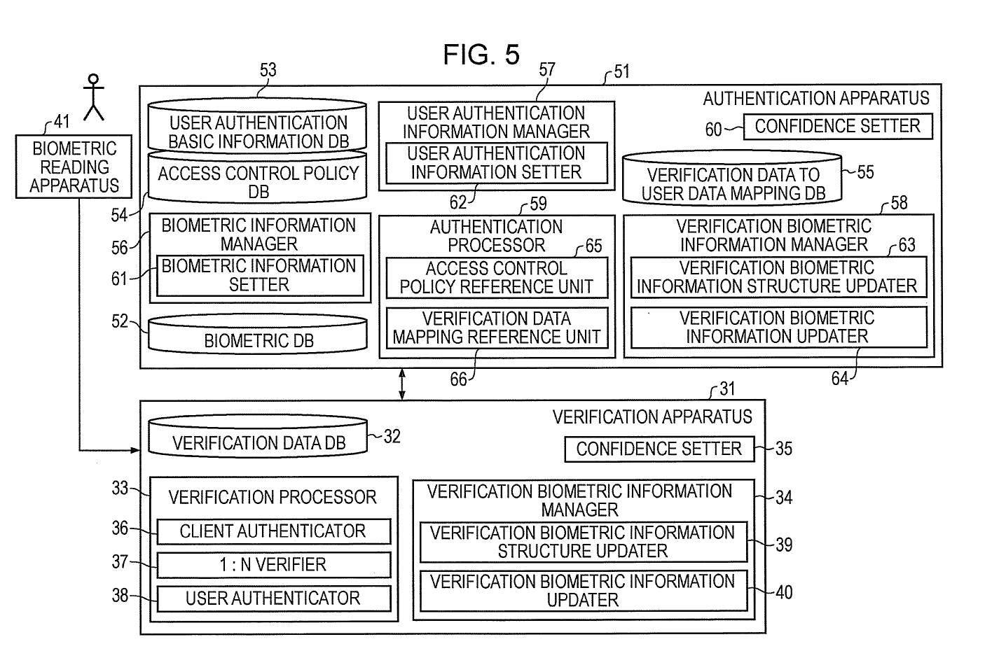

FIG. 5 illustrates a structure of verification apparatus 31, biometric reading apparatus 41, and authentication apparatus 51 in accordance with a second embodiment. In accordance with the second embodiment, the verification apparatus 31 is connected to the authentication apparatus 51 via a communication path. The authentication apparatus 51 authenticates persons based on the verification results of the verification apparatus 31. In accordance with the second embodiment, one group or a plurality of groups are assigned to the verification apparatus 31. If a plurality of groups are assigned to the verification apparatus 31, the group information reading apparatus 18 (see FIG. 1) for identifying a group of verification target persons or an input device for specifying a group of verification target persons may be used.

The verification apparatus 31 includes verification data database 32, verification processor 33, verification biometric information manager 34, and confidence setter 35. The verification data database 32 (storage unit) registers the biometric information of a plurality of persons on a per group basis. In group registration, users sharing one biometric reading apparatus 41 may be registered as one group, or as a plurality of groups.

If a plurality of biometric reading apparatuses 41 are connected to the verification apparatus 31, the users are grouped on a per biometric reading apparatus basis for management. If the users are grouped on a per biometric reading apparatus basis, a device ID identifying the biometric reading apparatus 41 may be used as the group information.

The verification processor 33 includes client authenticator 36, 1:N verifier 37, and user authenticator 38. In response to an authentication request from the biometric reading apparatus 41, the client authenticator 36 determines whether the biometric reading apparatus 41 is authorized to use an authentication service and then authenticates a client.

The 1:N verifier 37 acquires from the verification data database 32 a plurality of pieces of verification biometric information of a group identified by the device ID of the biometric reading apparatus 41 (or the input group information). The 1:N verifier 37 then performs a 1:N verification process between the biometric information of the verification target person and the plurality of acquired pieces of verification biometric information.

If the 1:N verification process indicates that matched verification biometric information is present, the verification target person is authorized to use the biometric reading apparatus 41. For example, if the verification apparatus 31 is used to manage entrance/exit, the verification target person is permitted to enter.

If the user is to be identified, the user authenticator 38 sends the location data indicating the storage location of the matched verification biometric information to the authentication apparatus 51 and then enquires of the user ID. The authentication apparatus 51 acquires the user ID with the location data mapped thereto in storage from a verification data to user data mapping database 55 to be discussed later, and then sends the acquired user ID to the verification apparatus 31.

The verification biometric information manager 34 (information update unit or index data management unit) includes a verification biometric information structure updater 39 and a verification biometric information updater 40.

In response to an update request from the authentication apparatus 51, the verification biometric information structure updater 39 and the verification biometric information updater 40 update the biometric information structure or the biometric information of the verification data of the verification data database 32. The confidence setter 35 performs an authentication process with the partner communication apparatus, thereby assuring reliability of communication through cipher communication.

The authentication apparatus 51 includes biometric database 52, user authentication basic information database 53, access control policy database 54, and verification data to user data mapping database 55. The authentication apparatus 51 further includes biometric information manager 56, user authentication information manager 57, verification biometric information manager 58, authentication processor 59, and confidence setter 60. The confidence setter 60 performs an authentication process with the partner communication apparatus, thereby assuring reliability of communication through cipher communication.

The biometric database 52 stores the biometric information of a plurality of users registered on at least one verification apparatus 31 with group information and personal identification information mapped to the biometric information. The biometric database 52 may store data including the same biometric data as the biometric data of the verification data database 32 in the verification apparatus 31 or may store data including the biometric information, corresponding to the biometric data, in a form different from the form of the verification data database 32.

The user authentication basic information database 53 stores user information, authentication service information, group information, terminal information, etc. The access control policy database 54 stores the name of a group using a terminal (such as a biometric reading apparatus), information regarding a user belonging to each group (such as a user ID), and policy data indicating authentication service used by the user.

The verification data to user data mapping database 55 (mapping data storage unit) stores data that maps the user ID to the location data indicating the storage location of the verification biometric information in the verification data database 32 of the verification apparatus 31. By referencing the verification data to user data mapping database 55, the user ID responsive to the location data of any the verification biometric information is acquired.

The biometric information manager 56 includes a biometric information setter 61. In response to a user request to add, delete, or modify the biometric information, the biometric information setter 61 searches the biometric database 52 for the verification biometric information of the user who has issued the request. The biometric information setter 61 then updates the verification biometric information. The biometric information setter 61 notifies the verification biometric information manager 58 that the verification biometric information has been updated.

The user authentication information manager 57 (user attribute information management unit) includes a user authentication information setter 62. Upon receiving from an administrator a update request of the user authentication basic information or the access control policy, the user authentication information setter 62 updates one of the user authentication basic information database 53 and the access control policy database 54. The user authentication information setter 62 then notifies the verification biometric information manager 58 of the update content of the access control policy.

The updating of the user authentication basic information includes the adding, the deleting, or the modifying of a user, the adding, the deleting, or the modifying of a group, the adding, the deleting, or the modifying of a terminal (such as the reading apparatus or the verification apparatus), or the adding, the deleting, or the modifying of an authentication service. The updating of the access control policy includes the adding, the deleting, or the modifying of a group authorized to use the terminal, the adding, the deleting, or the modifying of a user belonging to the group, or the adding, the deleting, or the modifying of an authentication service used by one of the group or the user.

The verification biometric information manager 58 (update request unit) includes verification biometric information structure updater 63 and verification biometric information updater 64. If the biometric information structure is modified as a result of the adding, the deleting or the modifying of the user belonging to the group, the verification biometric information structure updater 63 performs the following process. The verification biometric information structure updater 63 searches the verification data to user data mapping database 55 with the user ID as a key, and acquires the location data responsive to the user ID. The verification biometric information structure updater 63 then notifies the verification apparatus 31 of the location data and the modification content. Optionally, the verification biometric information structure updater 63 may the modification operation, such as adding, deleting, or modifying the user within the group, and then transmit to the verification apparatus 31 the updated data and the location data.

The verification biometric information structure updater 39 in the verification apparatus 31 updates the biometric information structure of the verification data database 32 for which the update request has been issued. The verification biometric information updater 64 receives an update notice of the biometric information from one of the biometric information setter 61 and the user authentication information setter 62, and then notifies the verification apparatus 31 of the location data of the verification biometric information as the update target and the modification content.

The verification biometric information updater 40 in the verification apparatus 31 updates the verification data database 32 in accordance with the location data responsive to the update request and the modification content. The authentication processor 59 in the authentication apparatus 51 includes an access control policy reference unit 65 and a verification data mapping reference unit 66. When the access control policy reference unit 65 receives from the verification apparatus 31 an enquiry of whether the authentication service of a particular client (such as the biometric reading apparatus 41) is to be performed, the access control policy reference unit 65 references the access control policy database 54. The authentication processor 59 then replies to the verification apparatus 31 about whether the enquired client is eligible for the authentication service.

In response to a request to transmit the user ID responsive to the location data from the verification apparatus 31, the verification data mapping reference unit 66 searches the verification data to user data mapping database 55 for the user ID with the location data as a key and acquires the user ID. The verification data mapping reference unit 66 then transmits the acquired user ID to the verification apparatus 31. The verification apparatus 31 thus acquires the user ID of the verification target person.

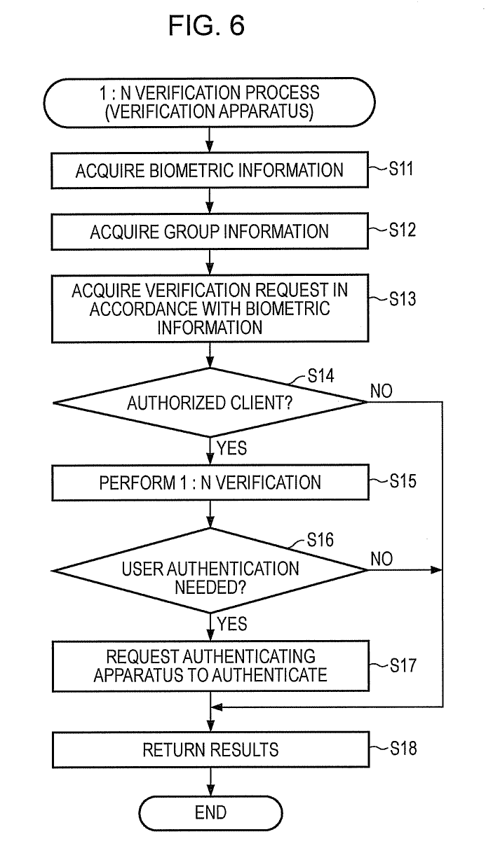

The operations of the verification apparatus 31 and the authentication apparatus 51 are described below with reference to flowcharts illustrated in FIGS. 6-10.

FIG. 6 is the flowchart of a verification process of the verification apparatus 31. The verification process is executed by a processor (not illustrated) in the verification apparatus 31. The flowchart illustrated in FIG. 6 is the function of the verification processor 33.

The biometric information of the verification target person is first acquired from the biometric reading apparatus 41 (S11 in FIG. 6). The group information of the verification target person is then acquired (S12). If the users of the biometric reading apparatus 41 are divided into a plurality of groups, the group information indicating the section of each user is read by the group information reading apparatus 18 (FIG. 1). If the users of the biometric reading apparatus 41 form only one group, the device ID of the biometric reading apparatus 41 may be used as the group information.

The biometric information verification request is received from the user (S13). The verification apparatus 31 determines whether an apparatus as a request source is an authorized client or not (S14). If the apparatus is an authorized apparatus (YES in S14), processing proceeds to step S15. The verification processor 33 performs the 1:N verification process. In the 1:N verification process, the verification apparatus 31 checks the biometric information of the verification target person against a plurality of pieces of verification biometric information falling within the same group. For example, in the 1:N verification process in step S15, the 1:N verifier 37 checks the biometric information of the verification target person against a plurality of verification biometric information of the corresponding group on the verification data database 32.

If it is determined that the apparatus is not an authorized apparatus (NO in step S14), processing proceeds to step S18 where the verification apparatus 31 notifies the requesting apparatus that the client is not eligible for verification. Subsequent to the 1:N verification process, the verification apparatus 31 then determines whether a user authentication is to be performed (S16).

If the user authentication is to be performed (YES in S16), processing proceeds to step S17. The verification apparatus 31 requests the authentication apparatus 51 to perform the authentication process. In the process step in S17, the verification apparatus 31 transmits to the authentication apparatus 51 the location data indicating the storage location of the matched verification biometric information and acquires the user ID responsive to the location data from the authentication apparatus 51. If the user authentication is not to be performed (NO in S16), processing proceeds to step S18.

If the verification apparatus 31 stores information that maps the location data indicating the storage location of the verification biometric information to the user ID, the user ID is acquired by referencing the information.

Finally in step S18, the verification results are returned to the requesting apparatus.

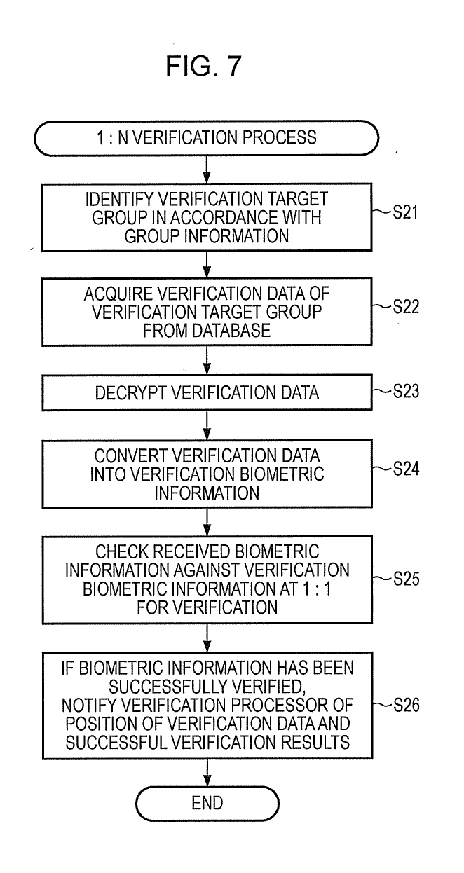

FIG. 7 is a flowchart illustrating in detail the 1:N verification process (in S15 in FIG. 6). The flowchart in FIG. 7 is the function of the 1:N verifier 37.

The 1:N verifier 37 identifies a verification target group in accordance with the acquired group (S21 in FIG. 7). For example, the group information is acquired when the group information reading apparatus 18 (FIG. 1) reads a IC card presented by the user.

The verification data responsive to a verification target group is read from the database (S22). For example, in the process step in step S22, the verification processor 33 acquires the verification data on a per group basis from the verification data database 32 in accordance with the acquired group information (such as the device ID identifying the biometric reading apparatus 41).

The 1:N verifier 37 then decrypts the acquired verification data (S23). The 1:N verifier 37 then converts the verification data into the verification biometric information (S24). Here, the verification data in an encrypted form of the biometric information is stored on the verification data database 32. Prior to the 1:N verification process, the verification data is decrypted into the original biometric information. If the biometric information is stored as is as the verification data, the decrypting step in S23 and the conversion step in S24 are not skipped.

The biometric information received from the biometric reading apparatus 41 is checked against the plurality of pieces of decrypted biometric information for verification (S25). If the verification results indicate a success, i.e., that matched verification biometric information is present, the 1:N verifier 37 notifies the verification processor 33 of the location data indicating the storage location of the verification data (matched verification biometric information) and the successful verification results (S26).

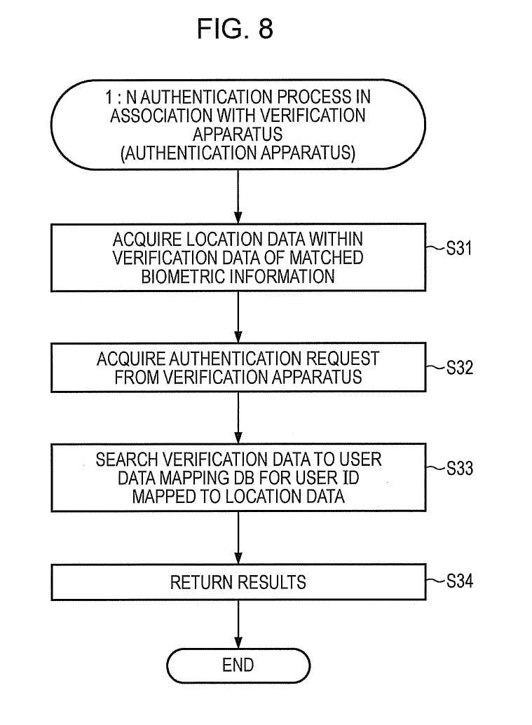

FIG. 8 is a flowchart of a user authentication process of the authentication apparatus 51. The flowchart illustrated in FIG. 8 is the function of the authentication processor 59 in the authentication apparatus 51. The authentication apparatus 51 acquires the location data indicating the storage location of the verification biometric information from the verification apparatus 31 (S31 in FIG. 8). The authentication apparatus 51 further receives an authentication request from the verification apparatus 31 (S32). The verification apparatus 31 verifies the biometric information by group, but if a personal authentication is to be performed, the verification apparatus 31 transmits the authentication request together with the location data to the authentication apparatus 51 and requests the authentication apparatus 51 to perform the authentication process.

The authentication apparatus 51 searches the verification data to user data mapping database 55 for the user ID responsive to the location data with the location data of the verification data serving as a key, and then acquires the user ID responsive to the location data (S33). Upon acquiring the user ID responsive to the location data, the authentication apparatus 51 returns the user ID as the authentication results to the verification apparatus 31 (S34).

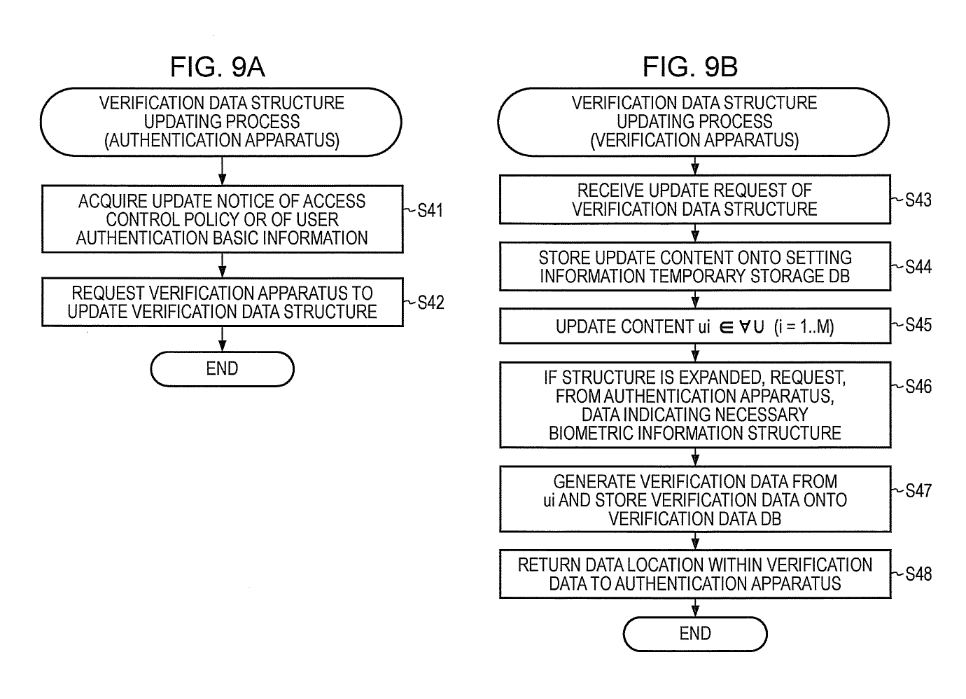

FIGS. 9A and 9B are flowcharts of verification data structure update processes of the authentication apparatus 51 and the verification apparatus 31. The processes of the flowcharts in FIGS. 9A and 9B are respectively the functions of the verification biometric information structure updater 63 in the authentication apparatus 51 and the verification biometric information structure updater 39 in the verification apparatus 31.

The administrator can modify the user authentication basic information and the access control policy. Upon receiving a modification request from the administrator, the user authentication information setter 62 in the authentication apparatus 51 adds, deletes, or modifies the users, the groups, and the terminals registered on the user authentication basic information database 53. If the modification request relates to the access control policy, the user authentication information setter 62 adds, deletes or modifies the groups eligible to use the terminal of the access control policy database 54, and the users belonging to the group, and the authentication service used by the user. The user authentication information setter 62 then notifies the verification biometric information manager 58 of modified part in the user authentication basic information and the access control policy.

Upon receiving one of the user authentication basic information and the access control policy, the verification biometric information manager 58 determines whether the corresponding biometric information structure is to be updated. If the biometric information structure is to be updated, the verification biometric information manager 58 updates the biometric information structure (S41 in FIG. 9A). In the process step in step S41, the verification biometric information structure updater 63 determines whether the update content of one of the user authentication basic information and the access control policy includes a modification of the biometric information structure. If the modification of the biometric information structure is included, the biometric information structure is modified by updating the verification data to user data mapping database 55 and the biometric database 52.

If the biometric information structure is to be modified, the authentication apparatus 51 requests the verification apparatus 31 to update the verification data structure (S42). Upon receiving the request to update the verification data structure from the authentication apparatus 51, the verification apparatus 31 stores the update content onto a setting information temporary database (not illustrated in FIG. 5) (S44).

If a plurality of update contents are received from the authentication apparatus 51, each update content (update data) is represented by a variable ui. The variable ui represents any update data within M pieces of update data U (i=1, . . . , M).

If the update data pointed to by the variable ui includes an extension of the biometric information structure, the verification apparatus 31 requests from the authentication apparatus 51 data indicating needed biometric information structure (S46).

The verification apparatus 31 generates the verification data (the verification biometric information) based on the data identified by the variable ui, and stores the verification data onto the verification data database 32 (S47). Process steps in steps S45-S47 are repeated until all the update data (ui: i=i, . . . , M) requested by the authentication apparatus 51 has been processed.

Subsequent to the modification of the verification data structure, the verification apparatus 31 returns the location data indicating the data location within the verification data to the authentication apparatus 51 (S48).

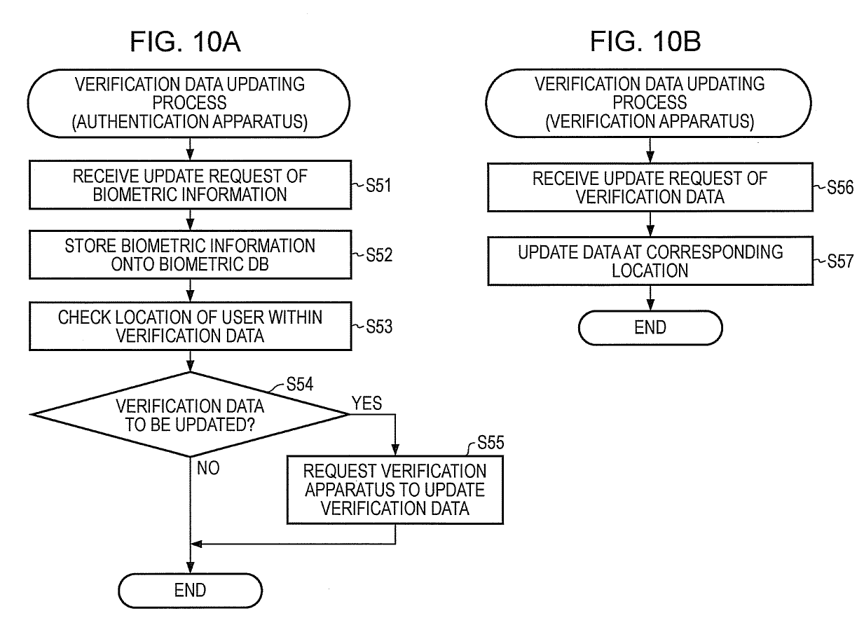

FIG. 10 is flowcharts of verification data update processes of the authentication apparatus 51 and the verification apparatus 31.

After personal authentication, the user can request the authentication apparatus 51 to update the biometric information (addition, deletion, and modification of the biometric information) using the user ID and the biometric information.

Upon receiving the request to update the biometric information from the user (S51 in FIG. 10A), the authentication apparatus 51 stores the updated biometric information onto the biometric database 52 (S52). For example in the process step in step S52, the biometric information setter 61 stores the updated biometric information onto the biometric database 52. The authentication apparatus 51 then notifies the verification biometric information manager 58 that the biometric information of the particular user has been updated.

The authentication apparatus 51 searches the verification data to user data mapping database 55 for the location data responsive to the user ID of the user whose biometric information has been modified, and then verifies the data location within the verification data on the verification data database 32 (S53). For example, in the process step in step S53, the verification biometric information updater 64 searches the verification data to user data mapping database 55 with the user ID as a key, and then acquires the location data responsive to the user ID.

The authentication apparatus 51 determines whether the verification data is to be updated (S54). If the verification data, i.e., the verification biometric information is to be updated (YES in S54), processing proceeds to step S55. The authentication apparatus 51 requests the verification apparatus 31 to update the verification data. In the process step in step S55, the verification biometric information updater 64 transmits to the verification apparatus 31 the modified biometric information, the location data of the modified biometric information, and the request to update the verification data. If the verification data is not to be updated (NO in S54), processing thus ends.

Upon receiving the update request of the verification data from the authentication apparatus 51 (S56 in FIG. 10B), the verification apparatus 31 searches the verification data database 32 for the verification biometric information specified by the received location data. The verification apparatus 31 also updates the verification biometric information hit in the search (S57). In the process step in step S57, the verification biometric information updater 40 updates the biometric information based on the location data and the modification content received from the authentication apparatus 51.

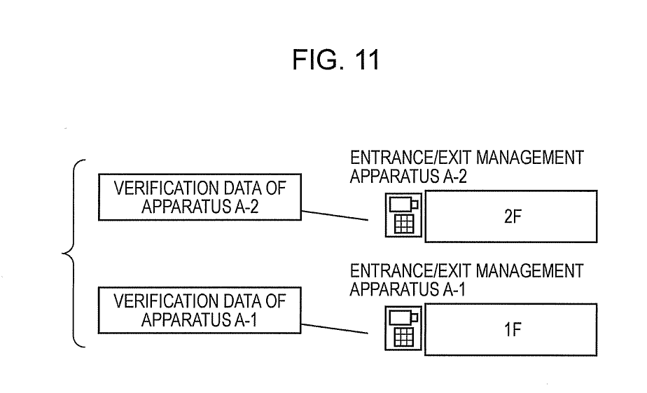

FIG. 11 illustrates a verification data management process of the verification apparatus 31 that functions as an entrance/exit management apparatus installed on each floor of a building. Entrance/exit management apparatuses A-1 and A-2 respectively installed on first and second floors of the building respectively include fingerprint reading devices. The users authorized to use the entrance/exit management apparatus A-1 is restricted to those who work on the first floor. The entrance/exit management apparatus A-1 stores as the verification data the biometric information of a plurality of users having the first floor 1F as attribute information. Similarly, the users authorized to use the entrance/exit management apparatus A-2 is restricted to those who work on the second floor 2F. The entrance/exit management apparatus A-2 stores as the verification data the biometric information of a plurality of users having the second floor 2F as attribute information.

In a system where the verification of each user of the entrance/exit management apparatus is operatively linked to the recording of entrance/exit time, the verification apparatus 31 transmits to the authentication apparatus 51 the location data indicating the storage location of the verification biometric information used in the verification and then receives the user ID of the verification target person. The entrance/exit management apparatuses A-1 and A-2 can manage the entrance/exit time of each user by storing the entrance/exit time of each verification target person and the user ID in a mapped state thereof.

If a user moves from a room on the first floor to a room on the second floor as the user is transferred from one section to another, the administrator modifies the user attribute information of the user (the user authentication basic information and the access control policy).

Upon receiving the request to modify a group of the users from the administrator, the authentication apparatus 51 modifies the corresponding user attribute information. For example, if a user is transferred from a section on the first floor to a section on the second floor, the user is deleted from the group which uses the entrance/exit management apparatus A-1 and then added to the group which uses the entrance/exit management apparatus A-2. The authentication apparatus 51 transmits to each of the entrance/exit management apparatuses A-1 and A-2 the request to modify the verification data. Upon receiving the update request of the verification data, each of the entrance/exit management apparatuses A-1 and A-2 adds or deletes the verification biometric information of the user in the group registered on the verification data database 32.

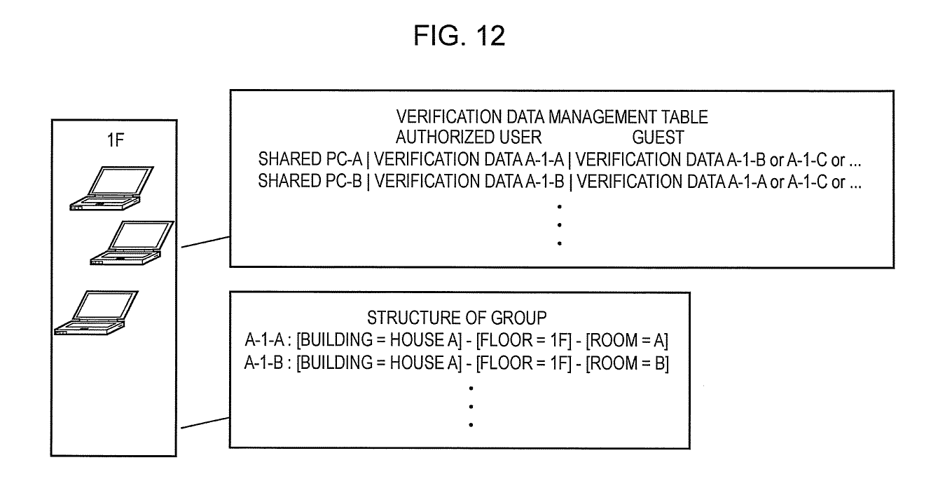

FIG. 12 illustrates how shared personal computers PC-A and PC-B having a fingerprint verification function manage verification data. In this example, each of the shared personal computers PC-A and PC-B has the function of the verification apparatus 31.

A verification data management table of the shared personal computer PC-A installed in room A registers there within the verification biometric information of users in group A-1-A in a room A on a floor 1F of house A of a building. The users in this group are registered as authorized users having the right to use. The verification biometric information of the users in room B on the floor 1F of the house A and the verification biometric information of the users in room C on the floor 1F of the house A, . . . , are respectively registered as verification data of groups A-1-B, A-1-C, . . . . These groups are registered as guests who are subject to usage limitation.

A verification data management table of the shared personal computer PC-B installed in room B registers there within the verification biometric information of users in group A-1-B in the room B on the floor 1F of the house A of the building. The biometric information of the users belonging to the group A-1-B is registered as the verification data of the authorized users. The verification biometric information of the users in other rooms, for example, room A on the floor 1F, room C on the floor 1F of the house A are respectively registered as verification data of groups A-1-A, A-1-C, . . . . These groups are registered as guests who are subject to usage limitation. The verification data management table recorded on each PC may contain only data that is likely to be verified at the PC. The verification data management table is stored on a recording device such as a hard disk device.

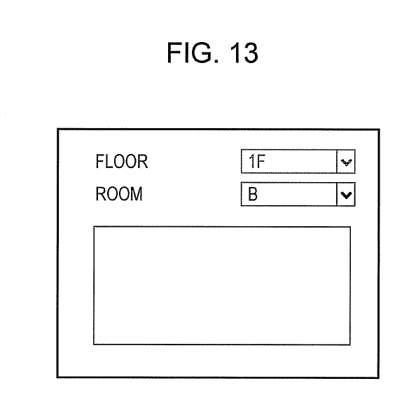

FIG. 13 illustrates an authentication screen on which the user attribute information is controlled. The authentication screen on a shared personal computer PC-B installed in room B has an initial value “B” as the value of a room. A building section is not displayed to the users, and a floor section (1F) is set to be non-modifiable.

A user A inputs “A” as the user attribute information related to the room on the authentication screen of the shared personal computer PC-A installed in the room A, and then performs a fingerprint authentication process. In order for the user A to use a shared personal computer PC-B installed in the room B, the user A inputs “A” as the user attribute information related to the room on the authentication screen of the shared personal computer PC-B, and then performs the fingerprint authentication process.

In the following discussion, the user attribute information is input on the authentication screen, and the fingerprint of the user is verified.

The user A as a tenant of the room A furnished with the shared personal computer PC-A may now use the shared personal computer PC-A. The initial value of the room on the authentication screen of the shared personal computer PC-A in the room A is “A.” The user A now causes the shared personal computer PC-A to read his or her fingerprint for authentication. The shared personal computer PC-A performs the 1:N verification process between fingerprints of a plurality of persons belonging to the room (the verification biometric information) and the fingerprint of the user A (the biometric information) by referencing the verification data management table illustrated in FIG. 13. If the fingerprint matching the fingerprint of the user A is registered in the group A-1-A, the user A is determined as an authorized user having all rights on the shared personal computer PC-A in the room A.

The user A as the tenant of the room A may now enter the room B, and use the shared personal computer PC-B in the room B. The initial value of the room on the authentication screen of the shared personal computer PC-B is “B,” and the user A modifies the value from the room “B” to the room “A” as the user attribute information. The user A then causes the shared personal computer PC-B to read his or her own fingerprint.

The shared personal computer PC-B at the room B references the verification data management table (FIG. 12), and performs the 1:N verification process between the fingerprint data of the plurality of persons belonging to the room A and the fingerprint data of the user A. If the verification results indicate that the fingerprint of the user A matches a fingerprint registered in the group 1-A-1, the user A is authenticated as a guest. The user A can use the shared personal computer PC-B in the room B as a guest user who is subject to usage limitation.

In accordance with the above-described second embodiment, the 1:N verification process can be performed on the biometric information on a per group basis without the need to identify the user. The user is thus smoothly authenticated without inputting the ID or the like. By verifying the biometric information on a per group basis, the verification time of the 1:N verification process is shortened.

The verification apparatus 31 manages the verification biometric information of a plurality of users on a per group basis with the personal identification, information of the persons (such as the user ID) unmapped to the verification biometric information. Even if the information is leaked from the verification apparatus 31, it is less likely that the biometric information of each person is mapped to the personal identification information. The risk of leakage of the personal information is thus reduced.

Since the verification of the biometric information is performed on a per group basis, no history information identifying who is the verification target person remains in the verification apparatus 31. Even if the information stored on the verification apparatus 31 is leaked, it is less likely that history information identifying each person is leaked.

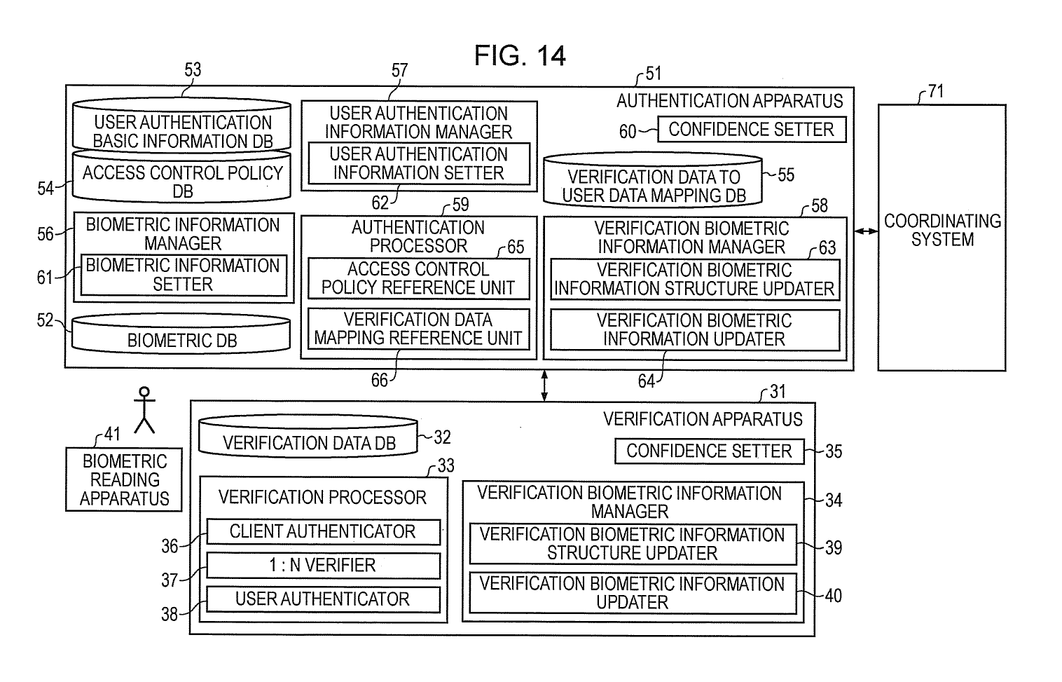

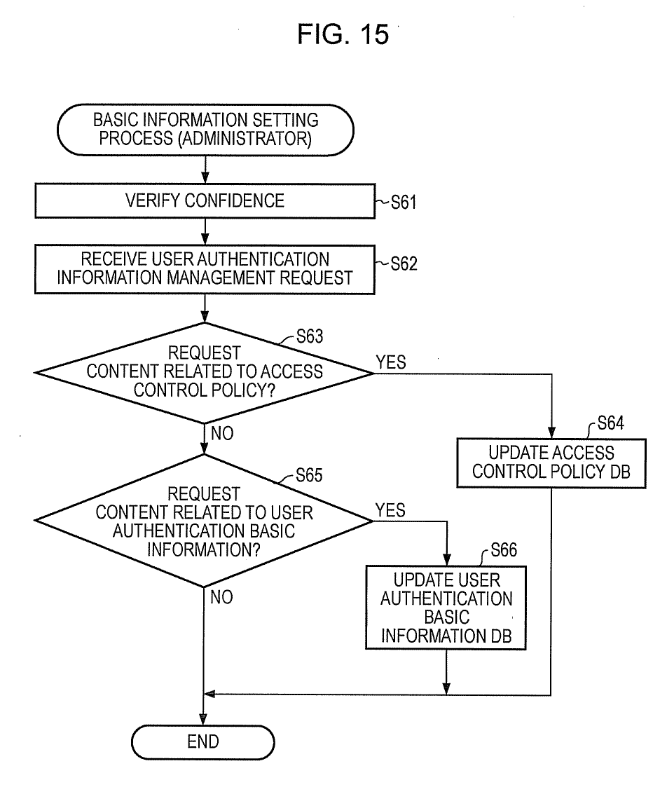

FIG. 14 illustrates authentication apparatus 51, verification apparatus 31, and coordinating system 71 in accordance with a third embodiment. In accordance with the third embodiment, the coordinating system 71 can update user basic information, thereby dynamically assigning a group to the verification apparatus 31. A method of assigning the group to the verification apparatus 31 is also applicable to each of the first and second embodiments. The authentication apparatus 51 and the verification apparatus 31, illustrated in FIG. 15, are identical in structure to the counterparts in FIG. 5. The blocks identical to those illustrated in FIG. 5 are designated with the same reference numerals and the discussion thereof is omitted here.

The administrator may now request the user basic information to be updated. FIG. 15 is a flowchart of a basic information update process of the authentication apparatus 51 in response to the update request from the administrator.

The authentication apparatus 51 authenticates the administrator in order to determine whether the administrator is an authorized administrator (verification of confidence) (S61 in FIG. 15). The authentication apparatus 51 receives a user authentication information management request (S62), and determines whether the content of the request is related to an access control policy (S63).

If the content of the request is related to the access control policy (YES in S63), processing proceeds to step S64. The authentication apparatus 51 updates the access control policy of the corresponding user on the access control policy database 54. In the process step in step S64, the user authentication information manager 57 updates policy data of the access control policy database 54 requested by the administrator. If the modification request of the user attribute information to modify dynamically the group of the user is received from another apparatus other than the administrator, the corresponding policy data on the access control policy database 54, such as data indicating the location of the user, is modified. The apparatus other than the administrator may be the verification apparatus or the authentication apparatus. If the verification results and the authentication results of the user are set to be one user attribute, the group to which the user belongs to is dynamically modified depending on the verification results and the authentication results of the user.

If the content of the request is not related to the access control policy (NO in S63), processing proceeds to step S65. The authentication apparatus 51 determines whether the content of the request is related to the user authentication basic information.

If the content of the request is related to the access control policy (YES in S63), processing proceeds to step S66. The authentication apparatus 51 updates the user authentication basic information database 53. In the process step in step S66, the user authentication information manager 57 updates the corresponding data of the user on the user authentication basic information database 53.

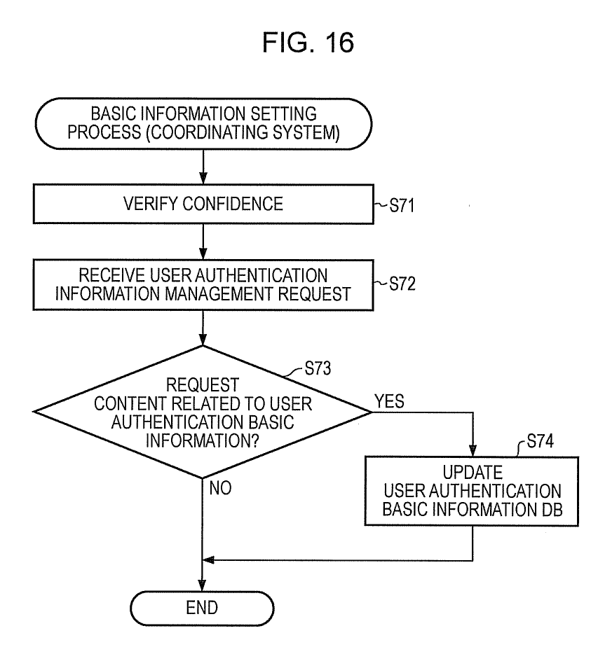

A process performed in response to a update request of the basic information of the user from the coordinating system 71 is described below. FIG. 16 is a flowchart of the basic information update process. The authentication apparatus 51 verifies confidence by performing an authentication process with the coordinating system 71 as a communication partner (S71 in FIG. 16).

The authentication apparatus 51 receives a user authentication information management request from the coordinating system 71 (S72). The authentication apparatus 51 then determines whether the content of the request is related to the user authentication basic information (S73).

If the content of the request is related to the user authentication basic information (YES in S73), processing proceeds to step S74. The authentication apparatus 51 updates the corresponding user authentication basic information of the user on the user authentication basic information database 53.

The third embodiment is further described. The entrance/exit management apparatus manages the location of the user and dynamically determines the group authorized to use the shared personal computers PC-A and PC-B illustrated in FIG. 12, based on the present location of the user.

The entrance/exit management apparatus is an IC card reading apparatus or the verification apparatus 31 of the third embodiment. The IC card reading apparatus reads information of an IC card of the user, thereby identifying the user and managing the entrance/exit of the user. The verification apparatus 31 verifies the biometric information of the user on a per group basis. The verification apparatus 31 transmits the location data indicating the storage location of the matched verification biometric information to the authentication apparatus 51. The authentication apparatus 51 then identifies the user ID responsive to the location data. In the discussion that follows, the entrance/exit management apparatus is the verification apparatus 31.

The shared personal computer PC-A installed in the room A on the floor 1F of the house A registers as an authorized user a person who can be at the room A or B and is presently on the floor 1F of the house A.

When the user A is authenticated by the entrance/exit management apparatus on the floor 1F of the house A, the location data indicating the storage location of the verification data used in the verification is transmitted to the authentication apparatus 51. The authentication apparatus 51 searches the verification data to user data mapping database 55 with the received location data as a key, and then acquires the corresponding user ID. The present location information as the user attribute information of the user A on the access control policy database 54 (or the user authentication basic information database 53) is written to be “A-1.”

The authentication apparatus 51 knows that the present location “A-1” is used as a condition of the authorized user of the shared personal computer PC-A, and determines that the verification data is to be updated. More specifically, the user A is added to the group of the authorized users of the shared personal computer PC-A on the access control policy database 54. The authentication apparatus 51 stores the verification biometric information of the user A to the group of the authorized users of the shared personal computer PC-A on the biometric database 52. In response to the modification of the user attribute information, the verification data of the shared personal computer PC-A is to be modified. The authentication apparatus 51 notifies the shared personal computer PC-A of the modification content of the verification data. To notify of the modification of the verification data, the authentication apparatus 51 may modify the verification data and transmit the modified verification data to the shared personal computer PC-A. Alternatively, the shared personal computer PC-A may update the verification data in response to the notified modification content.

Upon receiving the modification notice of the verification data from the authentication apparatus 51, the shared personal computer PC-A updates the verification data of own apparatus. In this way, the verification biometric information of the user A is registered onto the group defined by the room A, the floor 1F, and the house A of the verification data of the shared personal computer PC-A, and the user A is thus registered as an authorized user.

In accordance with the third embodiment, the 1:N verification process is performed on the biometric information on a per group basis without identifying the persons. The user is thus smoothly authenticated without inputting the ID or the like. By verifying the biometric information on a per group basis, the verification time of the 1:N verification process is shortened.

The verification apparatus 31 manages the verification biometric information of a plurality of users on a per group basis with the personal identification information of the persons (such as the user ID) unmapped to the verification biometric information. Even if the information is leaked from the verification apparatus 31, it is less likely that the biometric information of each person is mapped to the personal identification information. The risk of leakage of the personal information is thus reduced.

Since the verification of the biometric information is performed on a per group basis, no history information identifying who is the verification target person remains in the verification apparatus 31. Even if the information stored on the verification apparatus 31 is leaked, it is less likely that history information identifying each person is leaked.

Authentication condition is dynamically modified by dynamically modifying the group of the user based on the group attribute information indicating the present location of the user, or the like. For example, the authorization of the user as to whether to permit the user to use the shared computer is dynamically modified by the present location of the user.

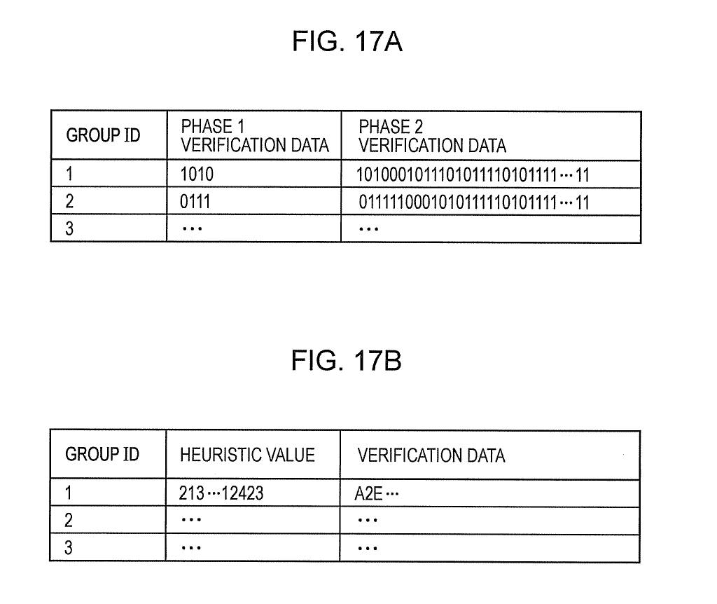

FIGS. 17A and 17B illustrate another example of the verification data.

FIG. 17A illustrates a structure of the verification data in the verification process that is multi-phased. For example, a central portion of a fingerprint is verified at a first phase, and the entire fingerprint is verified only if the central portion results in a high match rate.

FIG. 17A illustrates a data structure that is applied in a two-phase verification process of a first phase verification and a second phase verification. Verification data for the first phase and verification data for the second phase verification are stored with the group ID mapped thereto. For example, the data of the central portion of the fingerprint is stored as the verification data for the first phase verification, and the data of the entire fingerprint is stored as the verification data for the second phase verification.

The verification data may be the data arranged in a matrix configuration as illustrated in FIG. 3. Alternatively, the verification data may be arranged in a data structure in which a plurality of pieces of biometric information is continuously recorded.

FIG. 17B illustrates the group ID, metadata of the verification data, and the verification data in a mapped state thereof.

If the count of 1:1 verification cycles to N pieces of data is limited to less than N (for example, half the data is to be verified), a heuristic value for determining the search order of the verification data is stored as the metadata separate from the verification data.

FIG. 17B illustrates a data structure in which the group ID, the heuristic value, the verification data are mapped to each other.

For simplicity of explanation, one piece of verification biometric information may be constructed of 4 bits, and counted the number that each bit of the verification biometric information is 1 as a heuristic value. Only the verification biometric information that heuristic value has ±1 difference with the heuristic value of supplied biometric information is verified. The count of verification cycles is thus reduced.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal. The media described above may be non-transitory media.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A verification apparatus, comprising:
a storage unit storing a plurality of pieces of verification biometric information on a per group basis with personal identification information unmapped to the verification biometric information; and
a verification unit performing a 1:N verification operation on the verification biometric information of a verification target person read by a read unit and the plurality of pieces of verification biometric information on a per group basis.

2. The verification apparatus according to claim 1, further comprising a location data management unit managing location data indicating a storage location of the plurality of pieces of verification biometric information on the storage unit.

3. The verification apparatus according to claim 1, wherein the storage unit stores as one chunk of data the plurality of pieces of verification biometric information in the same group and causes the plurality of pieces of verification biometric information to be read at one reading operation.

4. The verification apparatus according to claim 1, further comprising:
an acquisition unit acquiring, when the verification biometric information of any user is modified, the modified verification biometric information and location data indicating a storage location of the modified verification biometric information on the storage unit; and
an information update unit updating the verification biometric information stored on the storage unit based on the location data and the modified verification biometric information.

5. The verification apparatus according to claim 1, further comprising:
an acquisition unit acquiring group information, indicating a new group including a user when the group which the user has belonged to is changed for the new group, and location data indicating a storage location of the verification biometric information of the user on the storage unit; and
an information update unit updating the storage location of the verification biometric information of the user based on the location data and the group information.

6. The verification apparatus according to claim 1, further comprising a user attribute information management unit dynamically updating the listing of the users belonging to the group based on user attribute information of each user.

7. The verification apparatus according to claim 6, wherein part of the data of the user attribute information is set to be non-modifiable, and the rest of the data is set to be modifiable.

8. An authentication apparatus in an authentication system including the authentication apparatus and a verification apparatus communicating with the authentication apparatus, the authentication apparatus comprising a mapping data storage unit and an authentication unit,
wherein when the verification apparatus stores on a storage unit a plurality of pieces of verification biometric information on a per group basis with personal identification information unmapped to the verification biometric information, the mapping data storage unit stores location data indicating a storage location of the plurality of verification biometric information on the storage unit and the personal identification information with the location information mapped to the personal identification information, and
wherein when a personal authentication request of a verification target person is received with the location data specified from the verification information, the authentication unit searches the mapping data storage unit for the personal identification information responsive to the received location data and performs personal authentication.

9. The authentication apparatus according to claim 8, further comprising:
a location data acquisition unit searching, when the verification biometric information of a user is modified, the mapping data storage unit and acquiring the location data responsive to the personal identification information of the user; and
an update request unit transmitting the modified verification biometric information and the location data to the verification apparatus and requesting the verification apparatus to update the verification biometric information.

10. The authentication apparatus according to claim 8, further comprising:
a location data acquisition unit searching the mapping data storage unit and acquiring the location data responsive to the personal identification information of the user when the group to which the user has belonged to is changed for a new group; and
an update request unit transmitting group information specifying the new group, and the location data to the verification apparatus and requesting the verification apparatus to update the verification biometric information.

11. The authentication apparatus according to claim 8, further comprising a management unit dynamically updating the listing of the users belonging to the group based on user attribute information indicating an area which each user is present within or a location of the user.

12. The authentication apparatus according to claim 8, further comprising a user authentication information setting unit setting authentication basic information including the biometric information and the personal identification information of the user, and policy data including group information indicating a group to which the user belongs.

13. A verification method, comprising:
storing on a storage unit a plurality of pieces of verification biometric information on a per group basis with personal identification information unmapped to the verification biometric information; and
performing a 1:N verification operation on the verification biometric information of a verification target person read by a read unit and the plurality of pieces of verification biometric information on a per group basis.
